(19) United States
(12) Patent Application Publication
(10) Pub. No.: US 2026/0297789 A1
(43) Pub. Date: Oct. 1, 2026

(54) A PARTICLE MEDIATED ANODISING PROCESS FOR WHITE ANODISED SURFACES

(71) Applicant: CIRRUS MATERIALS SCIENCE LIMITED, Auckland (NZ)

(72) Inventors: Fengyan HOU, Auckland (NZ); Christopher William GOODE, Auckland (NZ); lan John MARDON, Auckland (NZ); Rukmini GORTHY, Auckland (NZ); Da TANG, Auckland (NZ); Zhendi YANG, Auckland (NZ)

(21) Appl. No.: 19/476,044

(22) PCT Filed: Apr. 19, 2024
(86) PCT No.: PCT/IB2024/053811

§ 371 Date: Oct. 16, 2025

Related U.S. Application Data
(60) Provisional application No. 63/460,871, filed on Apr. 20, 2023.

(51) Int. Cl. C25D 11/10; C25D 11/08; C25D 11/12; C25D 11/16; C25D 11/24

(52) U.S. Cl. CPC C25D 11/10; C25D 11/08; C25D 11/12; C25D 11/16; C25D 11/24

(57) ABSTRACT

A method for anodising aluminium alloy including the step of providing a principally oxalic acid anodising bath with a tertiary butoxide; aging the anodising bath to condense the metal alkoxides to create metal oxide particles and acid esters; heating the bath to between 40 and 80 degrees; stirring the bath at between 200 and 700 rpm; immersing a workpiece in the bath and anodising at a constant current density of 1 to 4 A/dm² for a period of between 1 and 20 minutes or until the bath voltage reaches a threshold of between 100 and 200V; then anodising the workpiece for a period between 20 and 200 minutes at a constant voltage; to produce an anodised surface between 5 and 100 micrometres thick including a optically discontinuous pore structure which produces a white or near-white appearance.

This disclosure relates to an improved method for anodising aluminium or aluminium alloys using an aqueous anodising bath containing substantially organic acids. More particularly, the invention relates to a method of anodising an aluminium substrate, under controlled conditions, using an aqueous solution of carboxylic, and boric acids which incorporate particle media, including media derived from hydrolysed metal alkoxide, or long chain polymers, or leaching of intermetallic or alloy elements from diverse aluminium substrates, which modify the anodising process to produce a desired anodised coating morphology and create hard, essentially white surfaces.

### BACKGROUND

US Pat. Application No. 2022/0364253 A1 (to “Hou et al.”) “Method to Apply Coloured Coatings on Alloys” describes a method to anodise light metal substrates in an anodising bath comprising primarily phosphoric acid to develop an anodising film structure which when filled with nickel, or another metal by plating, structurally develops colours from black to red. The anodising solution described in Hou et al produces a regular pore side-pore structure which when filled with metal develops narrow bandwidth photonic resonators reflecting single colours. Such a surface cannot appear white because a white surface inherently requires a wide bandwidth reflector.

PCT publication WO 2012/119306 (to “Nano Institute”) describes a method to produce white aluminium oxide coatings by anodising to create a pore structure; infiltrating a first chemical into the pore structure; then infiltrating a second chemical into the pore structure. The two chemicals react in the pore structure to produce a white compound. A third acidic process modifies the alumina pore structure to increase the opacity of the anodising layer and increase the degree of whiteness of the surface. The method is overly complex to implement in an industrial setting and the surface whiteness depends critically on the second anodising step creating a sufficiently opaque anodising layer.

U.S. Pat. No. 10,760,175 B2 (“the Apple patent”) “White Anodic Films with Multiple Layers” teaches a multi-step method to produce white anodic films comprising at least two anodising steps, the first of which produces a dense surface pore structure for resilience and the second of which develops an irregular pore structure providing diffuse reflectance, introducing particles such as TiO₂ into the pores and sealing the pores. The process produces white appearing surfaces by managing the reflection through multiple layers, however the process is complex, and it is difficult to produce whiteness greater than an L of 90 when measured using the CIE Lab* method. This method, like the Nano Institute disclosure, relies on modifying the anodising pore structure and introducing a secondary material into an anodised pore structure to develop the surface colour. The multi-step process is complicated and difficult to control in an industrial setting.

Korean patent KR102244376B1 entitled, “White anodizing method using nanoparticles” teaches a method, like the Apple patent, for forming an anodic structure but adopts a vacuum to facilitate the infiltration of the nano material within the anodising structure.

### SUMMARY

This disclosure describes various aspects and examples that relate to developing novel anodising films for aluminium or aluminium alloys that exhibit a glossy white, matt white or opaque white appearance. In particular, in one aspect, there is described an anodising process mediated by particle or particle like compounds for production of white anodised surfaces.

In one aspect there is provided an aluminium anodising process to produce a white or substantially white nano-crystalline alumina surface on an aluminium substrate, the process comprising the steps of
i. Pre-treating an aluminium substrate;
ii. Immersing the aluminium substrate in an aqueous anodising bath comprising:
   a buffer,
   one or more particle sources,
   and one or more carboxylic acids; and
iii. anodising the aluminium substrate by following an anodising current and voltage regime to provide an anodised substrate comprising the anodised surface

In one example the anodising current and voltage regime includes:
i. A first period at a first constant current;
ii. A current ramp over a second period to a second constant current;
iii. Anodising at a second constant current until the voltage reaches a threshold then switching to constant voltage anodising; and.
iv. Conducting constant voltage anodising for a third period.

In another aspect there is provided an anodised substrate comprising an anodised surface, the anodised surface comprising a dense nano-crystalline bottom layer, a substantially nanocrystalline filled nanotubular layer, and a porous nanotubular layer having nanocrystalline walls. In one aspect, the anodised substrate is an aluminium substrate.

In one aspect there is provided a method for forming an anodised surface comprising a white oxide film; the method including pre-treating an aluminium substrate or an aluminium alloy substrate; anodising the substrate in an anodising bath, the anodising bath comprising an organic acid electrolyte containing a particle source from a hydrolysed alkoxide, or another acid activity modifier. The method may further include the step of polishing the anodised surface to increase the gloss. The method may further include the step of sealing the anodised surface to increase the coating durability.

In one example, the anodising surface produced by the method comprises a layered anodising structure having a random pore structure and having periodic optical discontinuities. A random pore structure is a structure without a regular geometric pore arrangement typical of anodised aluminium. The random pore structure having the ability to diffusely reflect all visible frequencies of light to produce a surface that has a white or substantially white surface appearance.

In one example, the method includes the further step of infiltrating the anodised structure having the random pore structure with sub 40 nm particles to increase the diffuse reflectance provided by the anodised surface.

According to a further example the aluminium alloy substrate or the aluminium substrate is pre-formed into an enclosure, equipment housing, device housing, window frame or other architectural, commercial, aerospace, or industrial component for which a cosmetic white or near white anodised surface provides a useful aesthetic, increases the performance of the surface, or provides other functional attributes.

In one example the particle source and alcohols resulting from hydrolysis of metal alkoxides in the anodization bath are substituted with a combination of metal oxide nanoparticles with particle size of approximately 100 nm and an alcohol.

In one example, the particle source and alcohols resulting from hydrolysis of metal alkoxides in the anodization bath are replaced by of metal ions or compounds leached during the anodising process and an alcohol.

In one example the particle source and alcohols resulting from hydrolysis of metal alkoxides in the anodization bath are replaced by a long chain organic acid or other long chain organic molecule.

It is to be appreciated that while certain aspects and examples have been described above, further aspects and examples will become apparent from the following detailed description and figures.

### BRIEF DESCRIPTION OF DRAWINGS

The disclosure will be readily understood from the following detailed description in conjunction with the accompanying drawings, wherein the reference numerals designate relevant elements.

FIG. 1 shows a cross sectional view of a substrate with a standard anodised surface which provides a translucent or translucent coloured surface.

FIG. 2 shows a cross sectional view of an optically discontinuous anodised surface according to certain examples where the structure provides a white appearance.

FIG. 3 shows a flowchart defining a process for forming an anodic film having a white appearance according to certain examples.

FIG. 4 shows a graph of the anodising voltage and current according to certain examples.

FIG. 5A-5H shows SEM surface and cross-sectional images of the anodic films produced according to certain examples.

FIG. 6A-6C shows XRD spectra of white appearing anodic films according to certain examples.

FIG. 7 is a simplified diagram of the anodising process apparatus showing the orientation of the nanoparticles in the coating formation.

FIG. 8 is a graph of coating colour, thickness, and surface pore diameter as a function of anodising time.

FIG. 9 is an image showing the optical effect produced by the nano porous zones in a white anodic coating.

### DETAILED DESCRIPTION

The detailed description makes reference to representative examples illustrated in the associated figures.

In the description below the word aluminium is to be understood as including all aluminium types and wrought aluminium alloys, such as pure 1000 series aluminium, high strength 2000 series aluminium alloys, high ductility 3000 series aluminium alloys, malleable 5000 series alloys, high formability 6000 series alloys and 7000 series aerospace alloys. The word aluminium may also include die cast aluminium alloys such as the A360.0 series, A380.0 series, C443.0 series and B390.0 series.

In the description and claims the preformed aluminium substrate or aluminium alloy substrate may include without limitation a window frame, an extrusion for a window frame, a case for a portable personal device, such as a watch case or a phone case; automobile components and extrusions, building components and extrusions; aeronautical components, aeronautical extrusions, marine components, marine extrusions; die cast or vacuum cast components, and the like.

In the description the word “about” as used herein in connection with a referenced numeric indication means the referenced numeric indication plus or minus up to 10% of that referenced numeric indication. For example, the language “about 10 g/L” covers the range of 9 g/L to 11 g/L.

As used in this specification, the terms “comprises”, “comprising”, “includes”, and “including” are to be construed as being inclusive and open-ended rather than exclusive. Specifically, when used in this specification, including the claims, the terms “comprises”, “comprising”, “includes”, and “including” and variations thereof mean that the specified features, steps, or components are included. The terms are not to be interpreted to exclude the presence of other features, steps, or components.

The term “substantially” as used herein, means for the most part, or mostly, or essentially, or to a great or significant extent.

As used herein in respect of the term “white” and “white colour” of the surface, white is intended to mean having an L*>90 and a and b* between −2 and +2.

The term C₁-C₆ alcohol as used in the specification refers to a straight chain or branched carbon entity having monohydric aliphatic alcohols. In one example the C₁-C₆ alcohol is derived from the in-situ hydrolysis of metal alkoxides added to the anodization bath. In another example a combination of metal oxide nanoparticles and any C₁-C₆ alcohol may be added to the anodization bath directly.

The processes described herein provides a white coloured hard anodic film on an aluminium substrate. Anodic films create a protective surface on components or parts formed from aluminium or an aluminium alloy by providing a relatively dense and thick metal oxide surface. The properties of these anodic films are desirable because they provide substantial hardness, chemical resistivity, and optical properties.

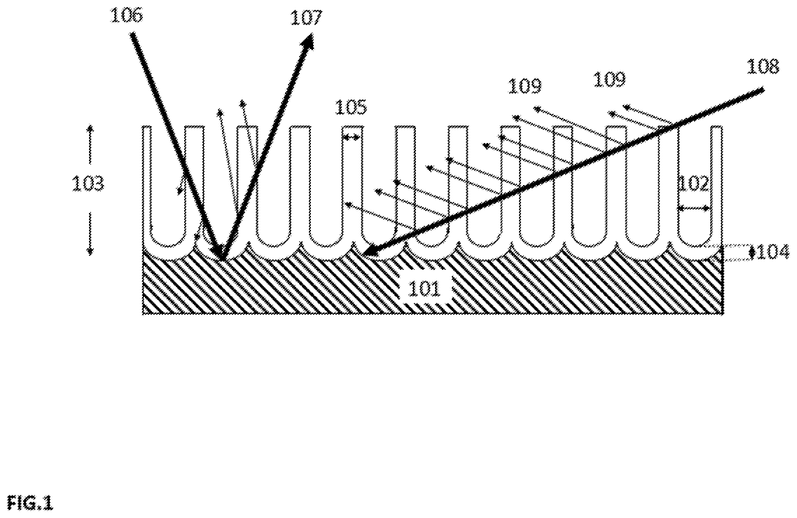

FIG. 1 shows a diagrammatic representation of typical anodising surface such as a film 100 produced on an aluminium substrate 101. The film 100 has a plurality of pores 110 having diameter 102 which can range from about 2 nm (formed in primarily sulphuric anodising baths) to about 200 nm (formed in primarily phosphoric anodising baths). The anodising surface 100 has a thickness 103 and can range from sub-micron to hundreds of microns for hard anodising. The film 100 further comprises a barrier layer having thickness 104 which depends on the anodising voltage and can vary from about 2 nm to about 200 nm or more. Pore wall thickness 105 and pore diameter 103a can range from about 5 nm to about 100 nm. In all cases the optical properties of the coating are driven primarily by the substantially transparent anodic film 100 which minimally interferes with the incident light that is mostly reflected by the underlying substrate as shown by the light rays 106, 107. The anodising surface refracts the light 106, 107, reflecting a small percentage, depending on the incident light angle as shown by reflected light rays 108, and low incidence ray 109. The optical properties anodising surface, such as a film 100 give rise to the typical silver/yellow iridescent appearance of anodised surfaces.

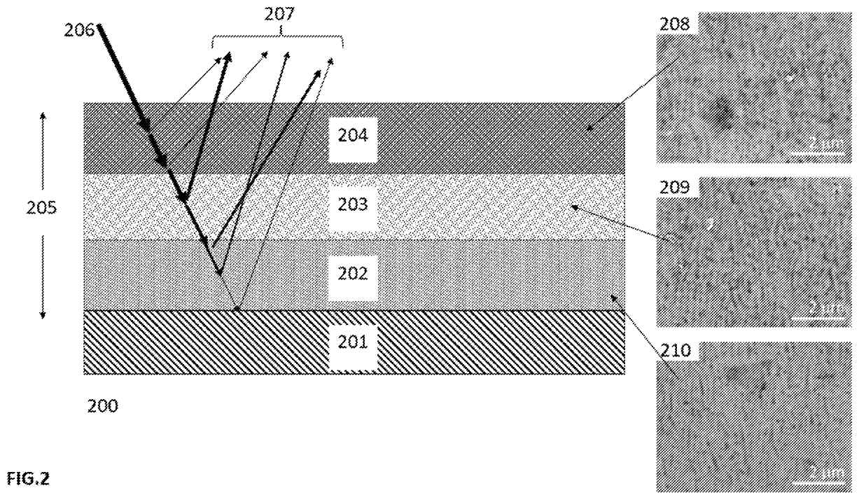

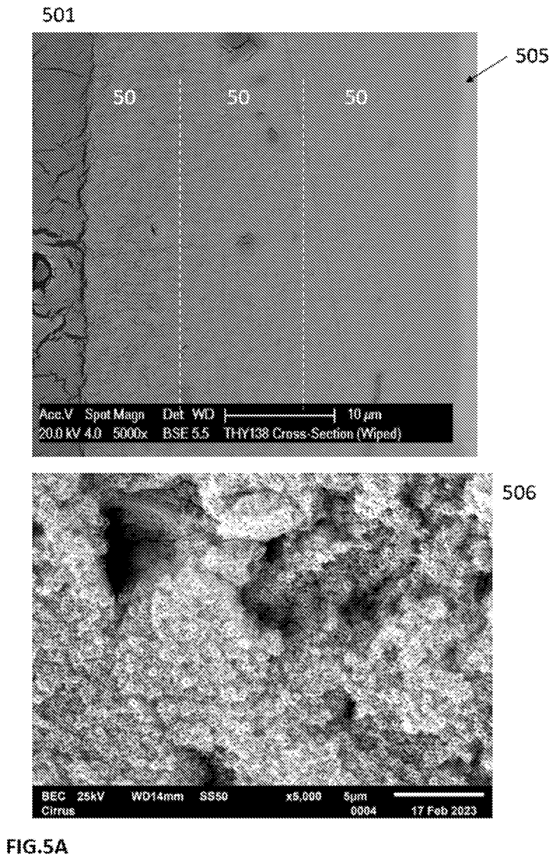

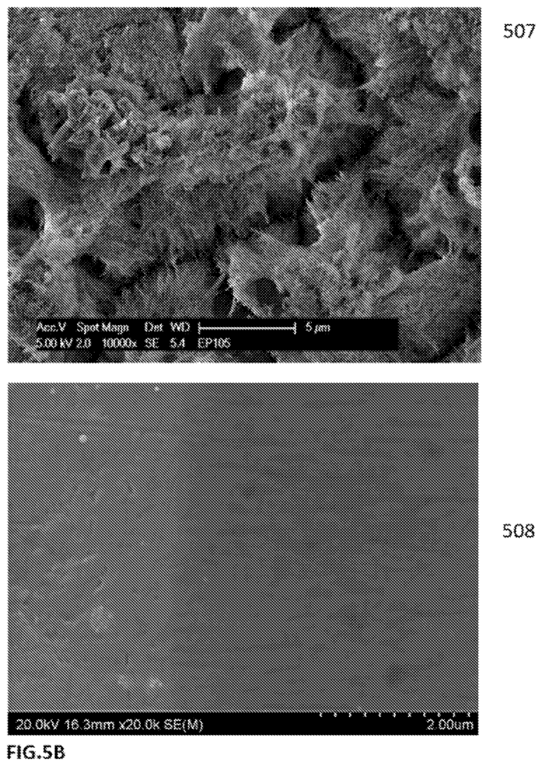

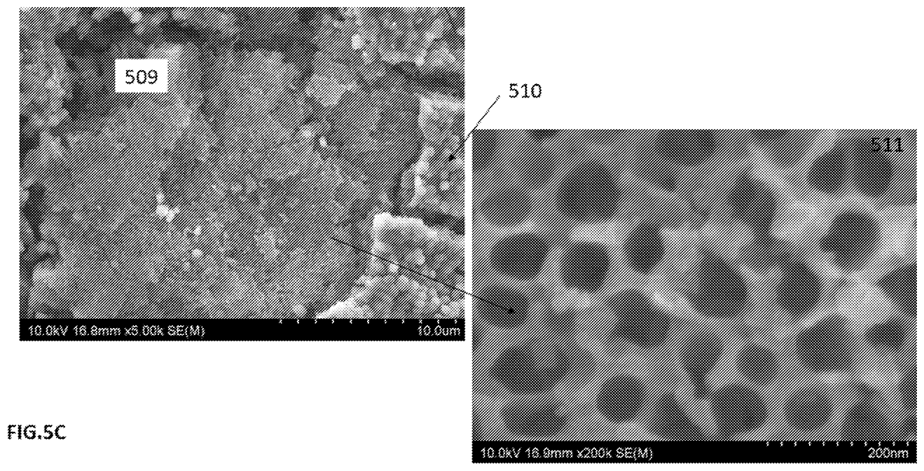

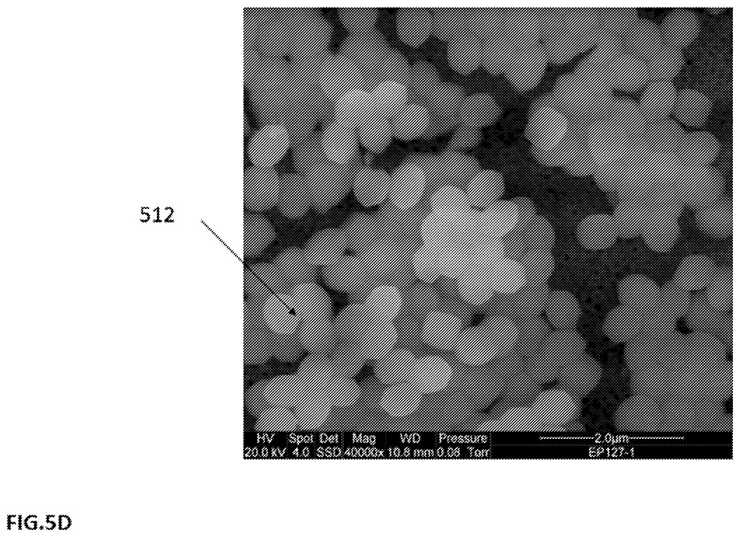

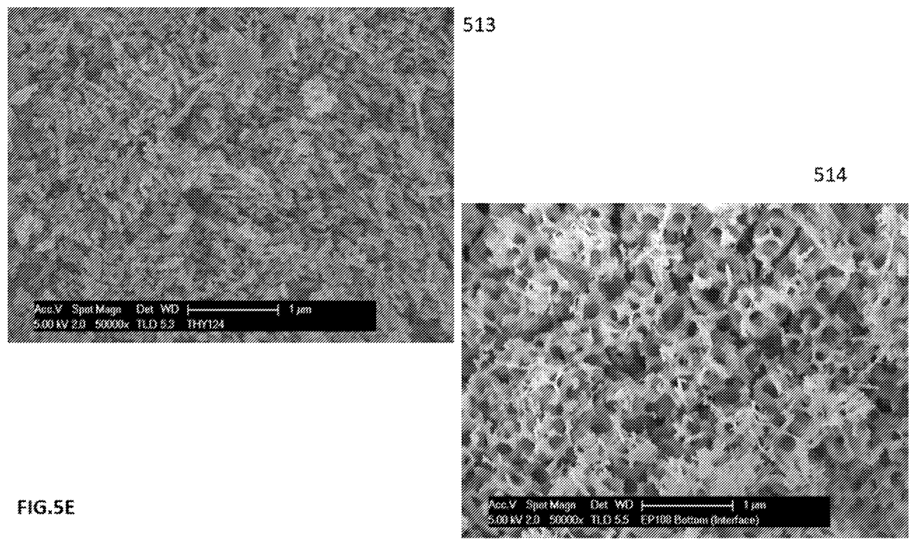

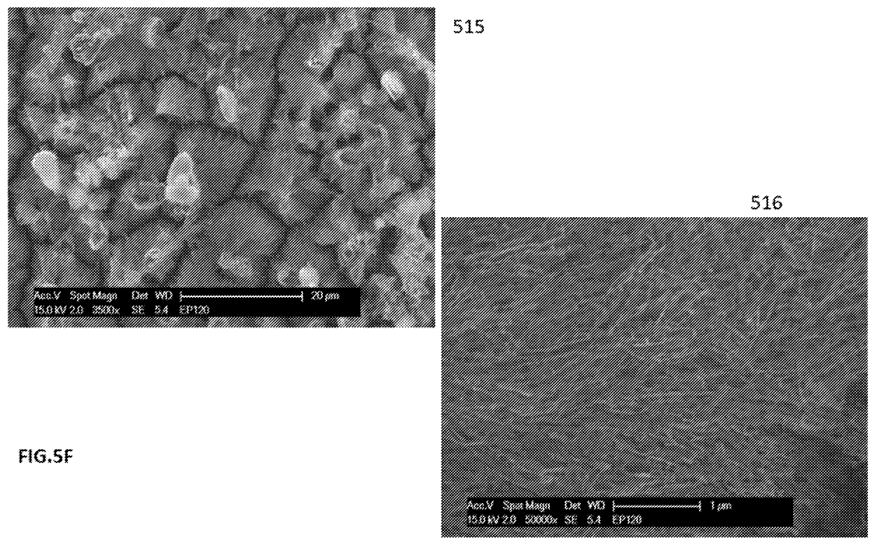

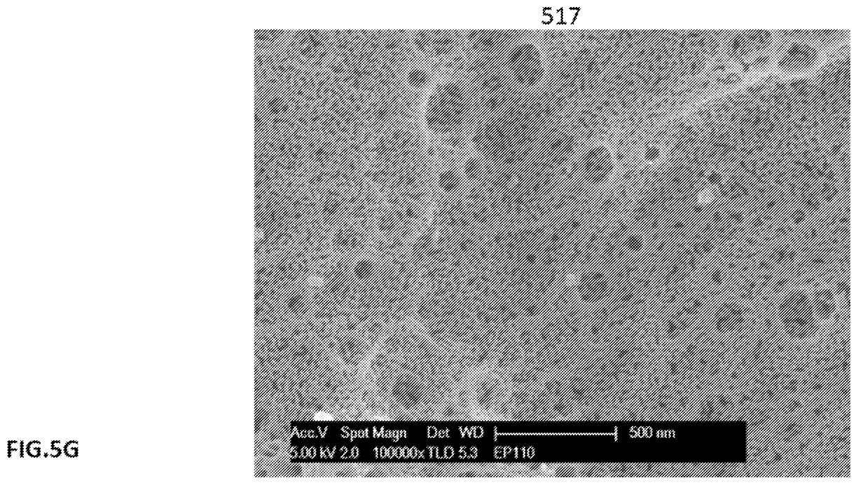

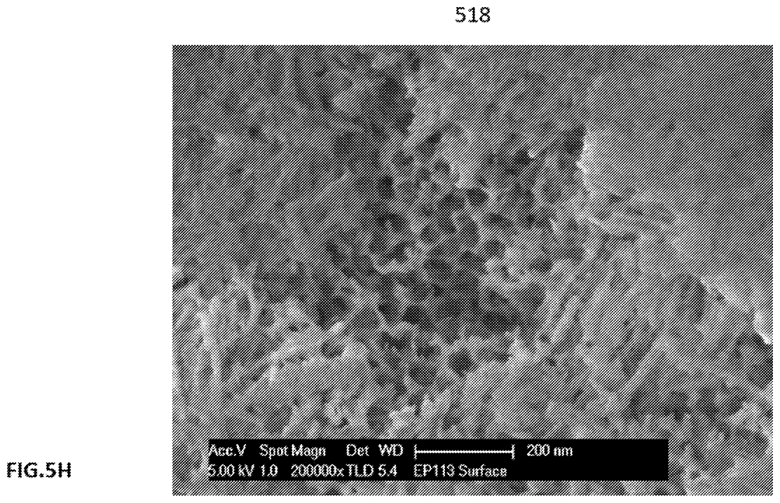

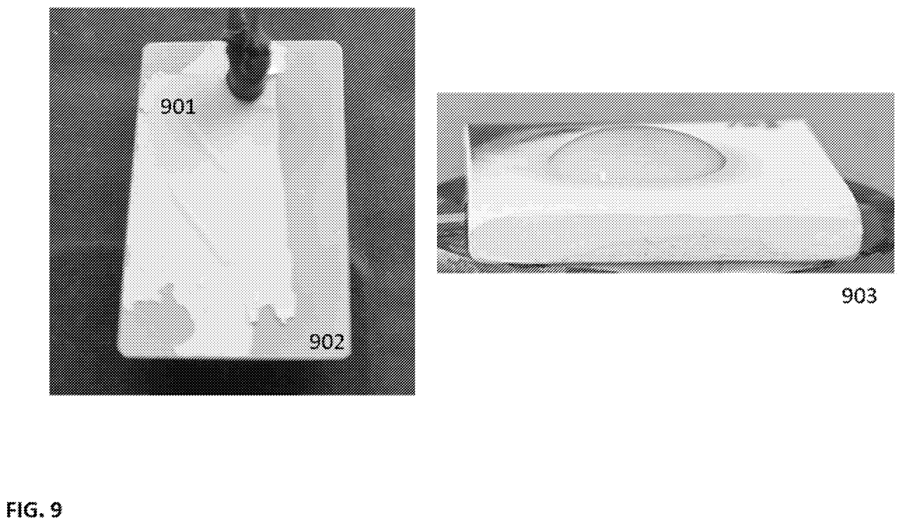

FIG. 2 shows a diagrammatic representation of an anodised surface 205 cross section on AL6061 aluminium alloy substrate 201 according to certain examples of the present disclosure. The figure also shows exemplar SEM imagery of cross-sectional morphology of the anodising surface. Interactions of the anodising structure with light may be understood with reference to FIG. 2, 200 and the associated SEM image snippets 208, 209, 210. Here, anodised surface 200 comprises the aluminium substrate 201 and surface film 205. Surface film 205 comprises a plurality of layers 202, 203 and 204. 202 is a dense nano porous layer substantially in contact with aluminium substrate 201. 203 is a multiple stack comprising multiple discontinuous nano porous anodising structures, and 203 being positioned between and in contact with 202 and 204. 204 is a branched nano porous layer located at an outermost position from 201. Each layer may exhibit a variety of thicknesses, dependent on the anodising parameters and substrate. However, in one illustrated example (FIG. 5), layers 202, 203 and 204 may have almost equal thicknesses of about 10 μm. Referring to FIG. 2, incident light ray 206, can have any incident angle without significantly changing the effect, and first impinges surface layer 204. This layer 204 has a random porous structure, see SEM 208, which mimics the appearance of frosted glass. Consequently, the incident light 206 is scattered with only a small portion of the light being reflected and scattered 207. Diminished scattered light ray 206, then reaches layer 203 having a random discontinuous structure. The random discontinuous structure, see SEM 209, of this layer provides a plurality of nanotube/alumina interfaces and 203 reflects or scatters a sizeable proportion of the incident light. Light 206 then enters layer 202. The layer 202 is the densest of the layers, see FIG. 2., SEM 210, and provides further pore/alumina interfaces reflecting or scattering substantially, or all remaining incident light 206. Hence, little of the incident light is reflected from the substrate. The overall scattered and reflected light 207 of FIG. 2 provides the anodised surface with a substantially white appearance. FIG. 9 is an image of a sample on which the anodised surface 200 was electrochemically exfoliated to understand the influence of the nanopores on the coating appearance. Here, FIG. 9, 901 shows at least the top two layers (compare with FIG. 2, layers 203, and 204) having a white appearance. The remaining coating is sufficiently translucent to be able to observe the underlying aluminium substrate (902, compare with FIG. 2, substrate 201 and layer 202). The inventors believe that the detached coating may be potentially used for catalytical and photocatalytic applications, nano-filtration devices, and in other technologies that involve a porous membrane.

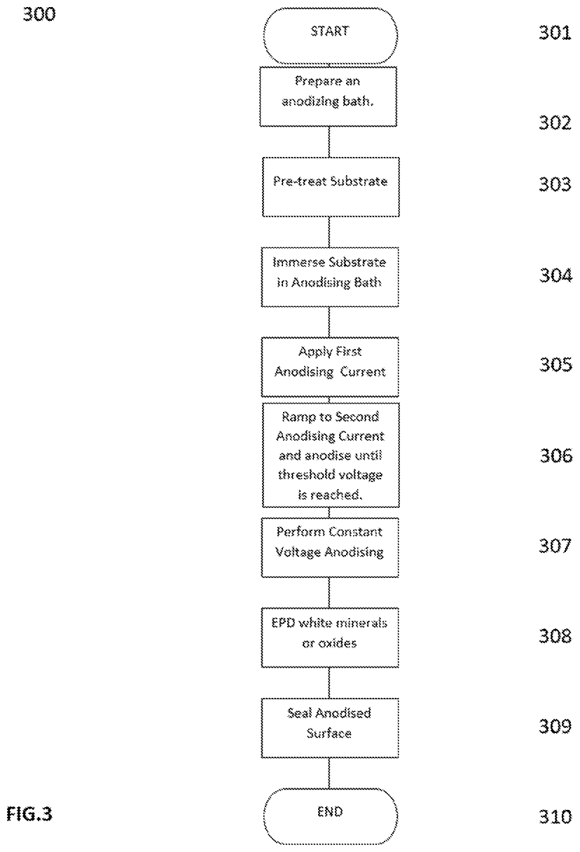

FIG. 3 shows a flowchart of the process to develop a white anodised surface according to certain examples of the disclosure. At step 301 the process begins.

At step 302 of FIG. 3 the process requires the preparation of an anodising bath. In certain examples the anodising bath comprises an aqueous solution of oxalic acid, boric acid and a carboxylic acid. In one example the oxalic acid is the primary bath acid and has a concentration of between about 10 and about 140 g/L, or between about 20 and about 60 g/L or preferably about 25-50 g/L, or more preferably about 42 g/L. In one example the boric acid acts as a bath stabiliser and has a concentration of between about 5 and about 20 g/L, between about 8 and about 16 g/L, preferably about 10 g/L. In one example the other carboxylic acid functions as a conductivity enhancer and has a concentration of between about 0.1 and about 5 g/L, preferably about 1 g/L. The carboxylic acid may be selected from a wide range of acids although citric acid is preferred. Attempting to anodise with this anodising bath produces an anodised surface, however the depth of anodising does not increase as alumina dissolution occurs at approximately the same rate as its formation.

One example modifies the anodising bath with a metal alkoxide compound. The metal alkoxide is a source from which metal micro and nano-particles may be formed. Many metal alkoxides may be adopted including, titanium butoxide, aluminium butoxide, zirconium propoxide amongst others. The quantity of metal alkoxide is not particularly limited, however the quantity of metal alkoxide required is sufficient to create a nano to micro-scale particle concentration that allows the anodization process to occur. In one example the alkoxide chosen is a metal butoxide, preferably titanium butoxide with concentration of between about 1 and about 80 g/L, or between about 10 and about 60 g/L, or between about 20 and about 40 g/L, in a preferred example the bath contains about 28 g/L of titanium butoxide.

In one example the bath may be aged to create a particle source. The particle source being generated in situ from a dispersion of metal oxide nano or micro-scale particles and an alcohol produced by condensation of metal alkoxides. The condensation of the metal alkoxide typically occurs naturally in the presence of water in the bath; however, the presence of acids in the bath impedes natural condensation, and the process must be catalysed. In one example formation of the nanoparticles and butanol is catalysed by the formation of hydroxides at the cathode during anodization. In an alternate example catalysation occurs by adding hydroxides, such as potassium or sodium hydroxide directly to the bath.

In one example the metal alkoxide may be titanium butoxide. Chemical reaction (1) summarises metal alkoxide condensation reaction for titanium butoxide (illustrated) in the anodising bath, to develop about 80 nm to about 3000 nm metal oxide particles and release the butanol.

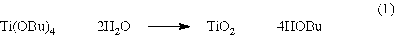

Without wishing to be bound to any theory the inventors believe that the alcohol in the presence of one or more metal oxides and one or more organic acids catalyses the creation of one or more stable esters that act as acid activity modifiers to support development of the white anodising surface and anodising structures on the substrate. Examples of suitable acid activity modifiers include stable polar esters such as butyl oxalate, butyl citrate, and combinations thereof.

The metal oxide nano or micro-scale particle source may be the oxide of any metal produced by condensation of a metal alkoxide. However, titania nanoparticles or titania micro-scale particles are preferred. Preferably, the metal oxide micro or nano-scale particles have a negative zeta-potential. This is so that the particles are attracted to the anode during anodising, however the zeta-potential may be any potential below-0.2 mV.

In one example the anodising bath further comprises a surfactant. The surfactant stabilizes the metal oxide micro or nano-scale particles by adsorbing onto the particle surface, amongst other functions. In principle any surfactant may be suitable. However non-ionic surfactants such as Tween® 20 (polyoxyethylene sorbitol ester), and cationic surfactants such as SDS (Sodium dodecyl sulphate), are preferred. The surfactant preferably has a concentration of between about 0.1 and about 5 mL/L, more preferably about 1 mL/L.

In one example the anodising process condenses the metal alkoxide to develop hydroxyl linked metal oxide particles.

The hydroxyl linked metal oxide particles may be of any size; however, the optimum size is sufficiently large to minimise absorption onto the anodised structure, and sufficiently small to remain readily suspended in the anodising bath. In one example the optimum size of the hydroxyl linked particles is between about 50 nm and about 5 microns. In one example the hydroxyl linked particles are titania particles, and the optimum size is or between about 500 nm and about 4 microns, or preferably about 2.5 microns. In one example the hydroxyl linked particles have a size measured by dynamic light scattering of about 3000 nm. In an alternative example the metal particles are zirconia, and the optimum size is between 50 nm and 250 nm, preferably ~100 nm.

In an alternate example the preparation of the anodising bath at 302 proceeds without the addition of a metal alkoxide, which is replaced by the addition of a quantity of preprepared nano or micro-scale particles and alcohol, preferably butanol. The nano or micro-scale particles added may in principle be any nano or micro-scale particles, preferably metal oxide nanoparticles, such as for example, Titanium (IV) oxide, anatase, 25 nm nano-powder from Sigma Aldrich. In one example, the quantity of nano-powder added is between about 1 and about 20 g/L preferably between about 5 and about 10 g/L. The alcohol required is the amount that would be released by the hydrolysation of the metal alkoxide, between about 30 and about 100 mL/L preferably about 65 mL/L. In a more preferred embodiment, white surfaces are produced from an anodising bath utilising preprepared nanoparticles rather than from micro and nanoparticles generated in situ in the anodising bath from metal alkoxides. Without wishing to be bound by theory, the inventors believe generation of micro and nanoparticles in situ produce inconsistency in particle size and acid activity modifying esters formed, which influences the surface produced.

In another alternate example, preparation of the anodising bath at 302 proceeds without the addition of the metal alkoxide. The metal alkoxide may be replaced by a metal oxide powder, for example magnesium oxide powder. Preferably about 1 g/L to about 2 g/L magnesium oxide powder from Sigma Aldrich. Or alternatively by metal oxide micro or nano particles developed in-situ by leaching during anodising of aluminium alloys in an anodising bath comprising carboxylic acid and boric acid. Without wishing to be bound by any theory the inventors believe that certain sub-micron metal oxides act as an acid regulator by participating in the dissociation of carboxylic acid in a manner similar to that of the stable polar esters.

In an alternative example the particle source and alcohols are replaced by succinic acid, long chain organic acids or other long chain organic molecules. A bath prepared using 2-propanol and polyethylene glycol (PEG), the PEG having a molecular weight of 400 g mol⁻¹ produced a white surface. The alcohol, preferably 2-propanol has a concentration of between about 20 and about 100 mL/L, preferably between about 40 and about 60 mL/L. The PEG MW 400 preferably having a concentration of between about 5 and about 30 mL/L preferably about 15 mL/L. Without wishing to be bound by any theory, the inventors believe that interactions between long chain organic molecules of PEG MW400 and carboxylic acids operate in a similar manner to the stable polar esters derived from metal alkoxides to modify the acid activity and allowing the nanostructure to grow in a way appearing as white.

With reference to FIG. 3, step 303 of the process 300 involves pre-treating a substrate to prepare the substrate for anodising. In certain examples pre-treatment comprises the steps of soaking the substrate in an alkaline bath to remove surface contaminants. A commercial alkaline cleaner, such as METACLEAN ZX from CMP Ltd of India may be used. Here the bath is operated at about 60 degrees Celsius for between about 5 and about 30 minutes. The alkaline soak may be followed by an acid etch step. The acid etch may comprise a solution of 10 volume % of sulphuric acid, 5 volume % of hydrofluoric acid in deionised (DI) water. The acid etch step in this case may be carried out at a temperature of between about 20 and 30 degrees Celsius for between about 3 minutes and about 5 minutes, preferably for about 4 minutes. Alternatively, any commercial solution containing ammonium bifluoride as the active chemical may be used. Following the acid etch a de-smut step may optionally be performed in a solution of about 50% nitric acid. The de-smut step, if required, involves dipping the substrate in the nitric acid solution for about 1 minute.

In an alternative example the substrate pre-treatment step 303 may involve polishing, preferably a mechanical polishing or electropolishing treatment. Electropolishing or mechanical polishing treatments decrease the substrate surface roughness and increase the uniformity of the anodising layer. The electropolishing step may adopt one of many well-known electropolishing processes for aluminium substrates and is continued to provide a mirror or near mirror surface on the substrate. A mirror or near mirror surface has a surface roughness, Ra, of between about 0.1 μm and about 0.5 μm, preferably about 0.2 μm or less. A mirror bright substrate may be preferred in certain applications to create a reflective rather than matte anodised surface.

Step 304, in FIG. 3 submerges the pre-treated substrate in a heated and agitated anodising bath. One preferred example heats the anodising bath to a temperature of between about 20 and about 90 degrees Celsius, or between about 30 and about 80 degrees Celsius, or more preferably about 45 degrees Celsius. A temperature of at least about 35 degrees Celsius ensures that the anodising process operates to create dense nanocrystalline structures to produce a white surface.

In one example the anodising bath is agitated. Many agitation methods are suitable provided the agitation is sufficient to maintain the metal nanoparticles in suspension. In one example the bath is agitated with magnetic stirring between about 300 and about 800 rpm, or about 400 rpm and about 700 rpm, or preferably about 600 rpm. In an alternate example agitation of the bath is achieved using external solution pumping. A further alternative example agitates the bath with low pressure compressed air. It a preferred example, sufficient agitation is maintained to achieve an even suspension of metal micro and nano-particles whilst also maintaining uniform bath temperature during anodising.

In step 305, of FIG. 3 a first anodising current is applied between the substrate (anode) and a cathode. The cathode may be any material that remains substantially inert in the bath while also being highly conductive. Suitable materials include carbon, titanium, stainless steel, and the like. In a preferred example the cathode is stainless steel. Suitable cathodes would be readily apparent to one of skill in the art.

In a preferred example constant current DC anodising is performed. Constant current DC refers to a constant (steady) time-independent current that does not change intensity with time. Alternatively, the method may also use pulsed DC anodising which may be beneficial when anodising certain Al alloys. Pulsed DC refers to a periodic current which changes in value, but not direction. In another example constant voltage anodising may be used.

At step 305 of FIG. 3., a first anodising current density is applied. Preferably the first anodising current density is between about 0.5 and about 3 A/dm², or between about 1 and about 2.5 A/dm², or preferably about 2 A/dm². The process initially preferably holds the first anodising current density for a period of between about 1 second and about 2 minutes, or between about 30 second and about 1.5 minutes, or preferably about 1 minute.

At step 306 of FIG. 3, the anodising current is optionally ramped from the first anodising current density to a second anodising current density. The second anodising current density being greater than the first current. Preferably the second anodising current density is between about 2 A/dm² and about 8 A/dm², or about 3 A/dm² and about 6 A/dm², or preferably 4 A/dm². Preferably, where the second anodising current is ramped from the first anodising current density to the second anodising current density, the ramp occurs over a period of between about 2 and about 4 minutes, or optimally about 3 minutes. The substrate and the anodising bath's nano or micro-scale particle content influence the second anodising current density required. For example, titania particles require about 4 A/dm² to produce optimum colour, while alumina particles require between about 6 A/dm² and about 8 A/dm². Preferably in each example the second anodising current density has a maximum current density which is selected to achieve an optimum colour and/or an optimum porosity of the anodised surface.

In a preferred example the second anodising current density is maintained until the voltage reaches a desired anodising voltage threshold. The anodising voltage threshold is influenced by bath composition, bath particle type and size, bath temperature, and substrate. The preferred anodising voltage threshold may be between about 80V and about 300V, or between about 120V and about 250V, or between about 140V and about 180V, or preferably about 150V. In one example where the anodising bath particles are titania particles, the particle size is about 3000 nanometres, the anodising bath composition comprises about 27 g/L oxalic acid, about 10 g/L boric acid, about 1 g/L citric, acid and about 24 g/L titanium butoxide; the substrate is 6061-T6 aluminium, the anodising voltage threshold is about 150V.

In an alternate example, which produces a glossy white surface, rather than a matte white surface, the anodising step (304, 305, 306, 307) is carried out on a polished or electropolished substrate. In this example the first current density and first period is divided into smaller portions comprising a first step, a second step and a third step. The first step of the first current density is preferably between about 0.5 A/dm² and about 3 A/dm², or preferably about 2 A/dm². Preferably the first current step period is held between about 5 minutes and about 25 minutes, or preferably about 15 minutes. Preferably, the second step of the first current density is between about 2 A/dm² and about 4 A/dm², preferably about 3 A/dm². Preferably the second step is held between about 5 minutes and about 25 minutes, preferably about 15 minutes. Preferably the third step of the first current density is between about 3 A/dm² and about 5 A/dm², preferably about 3.4 A/dm²/Preferably the for a third step is held between about 5 minutes and about 25 minutes, preferably for about 15 minutes. Preferably, the second current density is between about 3 and about 6 A/dm², preferably about 4 A/dm², for a period until the voltage reaches the threshold anodising voltage.

At step 307 of FIG. 3., an anodising rectifier may be switched from constant current mode to constant voltage mode and the anodising voltage may be maintained at the anodising voltage threshold for a voltage control period of between about 10 minutes to about 200 minutes, or about 50 minutes to about 150 minutes, or about 80 minutes to about 130 minutes, preferably between about 90 minutes and about 120 minutes, or until the current falls below a 10% of the first current density threshold. The threshold being less than about 0.5 A/dm², or less than about 0.2 A/dm², preferably less than about 1 A/dm².

In a preferred example the anodising current density gradually reduces as the dense optically discontinuous oxide film which provides the white surface forms.

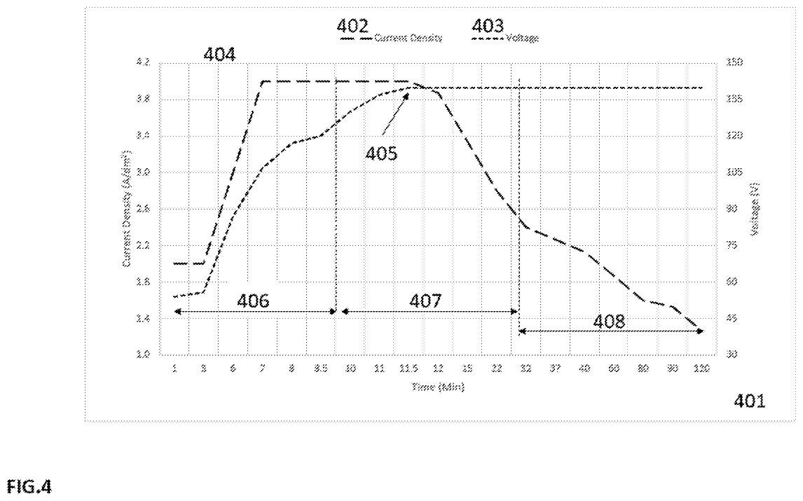

In an alternate example the rectifier is not switched to constant voltage mode and the current density is maintained at the second current density for the remainder of the anodising period. Maintaining a high current density promotes anodising surface (such as a film) growth and shortens the time to create the white anodised surface. Rather, to maintain the maximum anodising voltage 405 of FIG. 4, the temperature of the anodising bath is controlled. Here, lowering the temperature increases the voltage and vice versa, thus, to maintain the voltage at the optimum point the when the voltage becomes too high the temperature is increased and when the voltage becomes too low the temperature is decreased.

With reference to FIG. 4, a voltage current curve 401 is shown for a preferred example although it is to be appreciated that other voltage current curves may also produce white surfaces. FIG. 4, line 402 shows the current density applied, while line 403 shows the anodising cell voltage. In this example an energising voltage 404 was applied to the anodising cell at t=0 with a constant current 402 of about 2 A/dm² and the anodising cell voltage 403 was around 52V. The process maintained the constant current 402 for about 3 minutes while the anodising cell voltage 403 rose to about 60V. Thereafter the current density 402 was ramped 404 up to a value of approximately 4 A/dm² over a period of about 3 minutes. The cell voltage 403 slowly rose as the anodising film thickness grew. The period 406 is largely associated with producing the porous surface 204 or FIG. 2, however the bath acids further etch this exposed surface and are partially responsible for the structure. At point 405 of FIG. 4, once the cell voltage reached the desired threshold voltage 405 for white anodising layer growth, the rectifier was switched to constant voltage mode. Thereafter the current density 402 slowly reduced as the anodising film increased in thickness until anodising was completed, in this case after two hours in total. Periods 407 and 408, respectively, reflect production of layers 203 and 202 as also described for FIG. 2.

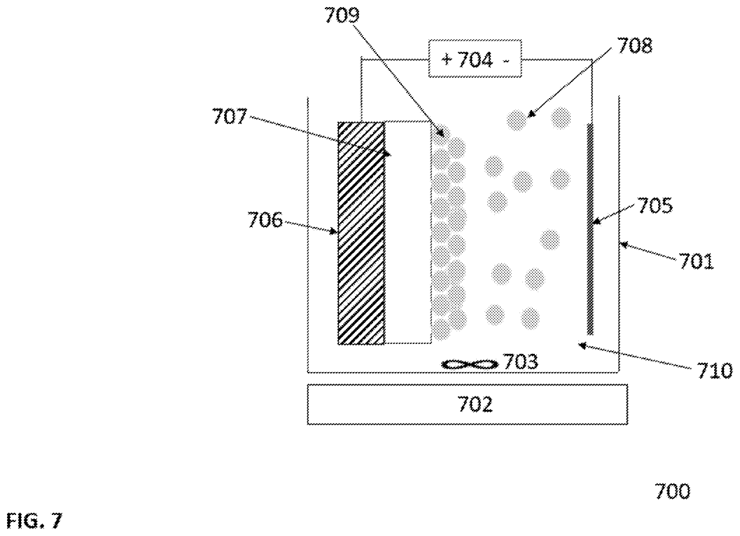

FIG. 7 shows a diagram of an anodising cell 700. The anodising cell 700 comprises a bath container 701, a heater 702, a stirrer 703, a power source 704, a cathode 705, and a workpiece/anode 706. The anodising bath further comprises a bath containing acids and surfactants 710, metal micro- or nano-particles 708, which are surfactant coated.

Without wishing to be bound by any theory the inventors believe the metal- or micro or nanoparticles in the bath form a loosely coupled electrophoretic layer 709 on or in the anodised surface (see FIG. 7). This loosely coupled layer 709 significantly slows diffusion of acids from the anodising bath 710 to the surface of substrate 707, which modifies the anodising process and produces an optically discontinuous nanocrystalline anodising structure of the invention.

In a preferred example anodization occurs in three stages, the first is creation of a substantially nanocrystalline layer. Here, the native oxide layer on the aluminium substrate together with a surfactant acid film combine to support an initial anodising voltage of approximately 50V. In certain examples, the surfactant(s) and organic acid(s) (e.g., citric acid), change the wetting behaviour of the aluminium's native oxide surface, which in turn moderates the anodising bath's ability to dissolve the native oxide surface, preventing pitting and encouraging coating growth. The anodising bath acids facilitate electrochemical dissolution of the aluminium substrate material, equation 2, and the building of the barrier layer and pore walls, equation 3.

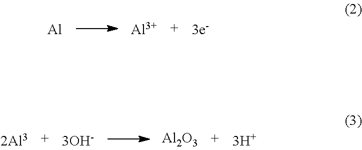

While the equations (2) and (3) represent a standard anodising process the actual chemical interchanges at the substrate are more complex. The inventors determined that an anodising bath without a condensed alkoxide, or metal micro- and nano-particles and alcohol failed to produce any significant depth of anodising. Without wishing to be bound by any theory, inventors believe that interactions between the carboxylic acid; organic compounds, including alcohol derived compounds; and metal micro and nano-particles may be required to enable the formation of persistent anodic structures, i.e., without these interactions they form and dissolve at equivalent rates. FIG. 5B, 507 shows a surface SEM of an aluminium sample anodised in a bath without metal alkoxide, which shows the typical structures associated with excessive acid dissolution of the alumina. A pore structure is visible under wispy surface structures. The inventors believe that adsorption of metal micro- and nano-particle derived compounds including alcohols on the anodised surface may retard dissolution of the anodic structures.

The first anodising stage, occurs during period 406 of FIG. 4, developed the nano porous outer layer, as shown in 502 of FIG. 5A, and 202 of FIG. 2. At the end of period 406 of FIG. 4 sufficient metal micro- and nano-particles had coalesced onto the anodised surface 201 by electrophoretic transport to influence the anodising process chemistry. Without the presence of metal micro- and nanoparticle sources and associated materials, a regular anodising structure continued to develop. FIG. 5B, 508 shows a cross section SEM of a coating produced from an anodising bath in which the particles remain at nano scale, i.e., <100 nm. Here, the anodised structure comprises porous nanotubes from substrate to surface (i.e layer 202 in FIG. 2). At sizes above 100 nm, the metal micro- and nano-particles can form an adherent electrophoretic deposition (EPD) layer on the anodising film, while still allowing development of a substantially consistent porous nanotube structure. Particles above 1 micron in size were found to form a non-adherent layer on the anodised surface which constrains chemical diffusion into the pores. The inventors found that with this layer in place, the anodising cell voltage drop resulted from a combination of the anodising process voltage drop, as seen in FIG. 4, the voltage drop created by ionic diffusion limits in the nano tubes, and the voltage drop across the particle surface of up to about 100V in the case of titania particles with Tween 20 on the surface.

The second anodising stage, occurring through periods 407 and 408 of FIG. 4, developed the layers 503 and 504 of FIG. 5A (also 203 and 204 in FIG. 2). Here, increasing surface particle density limited the interdiffusion of chemical species between pores and the anodising bath. Impeding the anodising process either by nano particle material interactions or alloying elements interactions from aluminium substrate, initially favours the growth of adjacent non-blocked pores, causing pores to bifurcate, as seen in FIG. 2 209 and 210. Once a substantial number of pores became partially, substantially or completely obscured by metal oxide nano particles, the pores became pH polarised, varying from strongly acidic near the aluminium substrate to more alkaline towards the anodising surface. Excess Al³⁺, i.e., aluminium ions not immediately incorporated into the anodising structures (FIG. 2, 202-204) at the base of the pores migrated to the alkaline pH regions, under the influence of the electric fields, where they combined with hydroxide ions to produce aluminium hydroxide. The aluminium hydroxide adsorbed onto the pore walls and developed a substantially nanocrystalline filled nanotubular middle layer as seen at 503 of FIG. 5A and 203, 209 in FIG. 2. These structures are principally responsible for light scattering which create the white surface colour.

The growth of middle nano structures 203/503 and 204/504 (FIG. 2/FIG. 5), further constrained diffusion through the layers which lowered the anodising current. As the current dropped below a threshold, as seen between 407 and 408 of FIG. 4, the final structures of layer 203/503, and 204/504 formed. The thickness ratio of the three observed layers, FIG. 5A 502:503:504 (FIG. 2, 202, 203, 204), is between about 1:0.4:0.5 to about 1:0.8:1.2.

Elements in the alloys affect the formation of the surface during anodising from 406 to 408. Insoluble and non-anodisable alloying elements, such as silicon or silicon-magnesium precipitation, will stay in the anodic layer as an inclusion. Presence of such alloying elements in an alloy may hinder the growth of the anodic film but may increase the light scattering points. Alloy elements, such as copper, would leave a hole in the anodic layer formation, and thus promote formation of side pores. Alloying elements, such as magnesium and zinc, would be oxidized but less preferred than aluminium, leaving oxide of magnesium and zinc in the anodic structure.

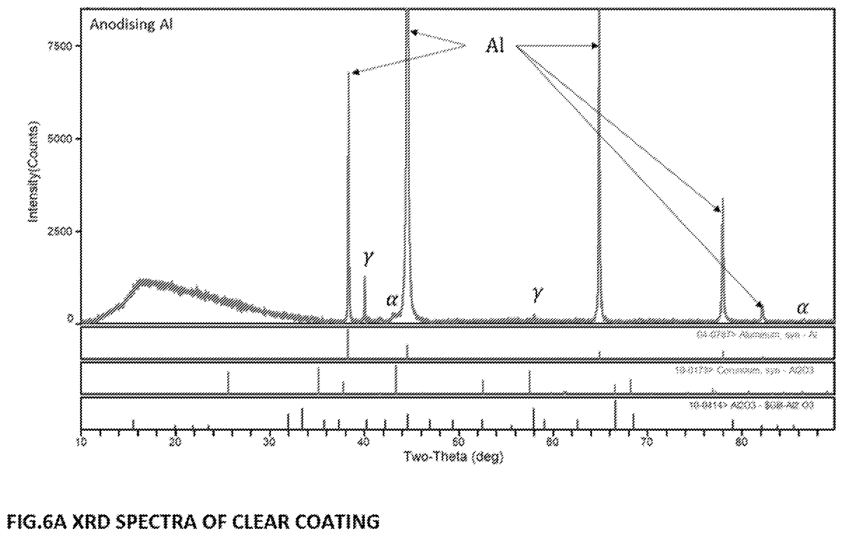

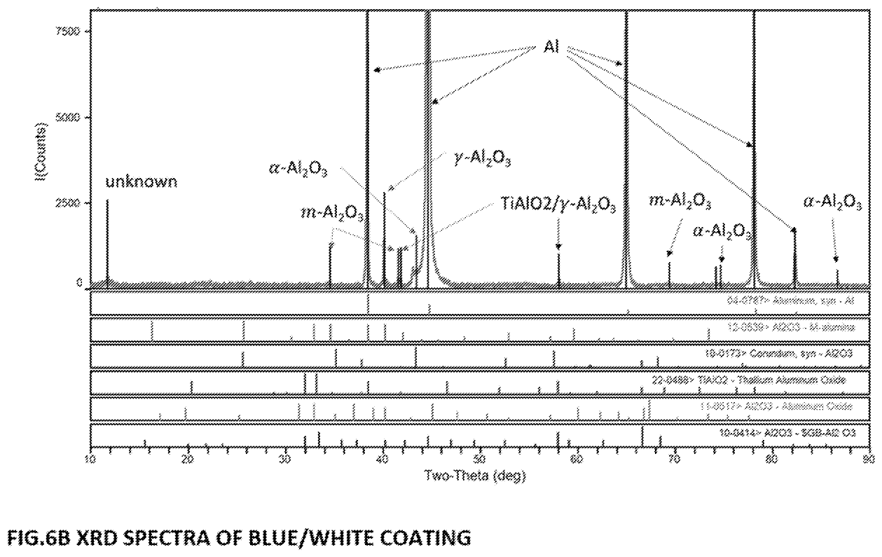

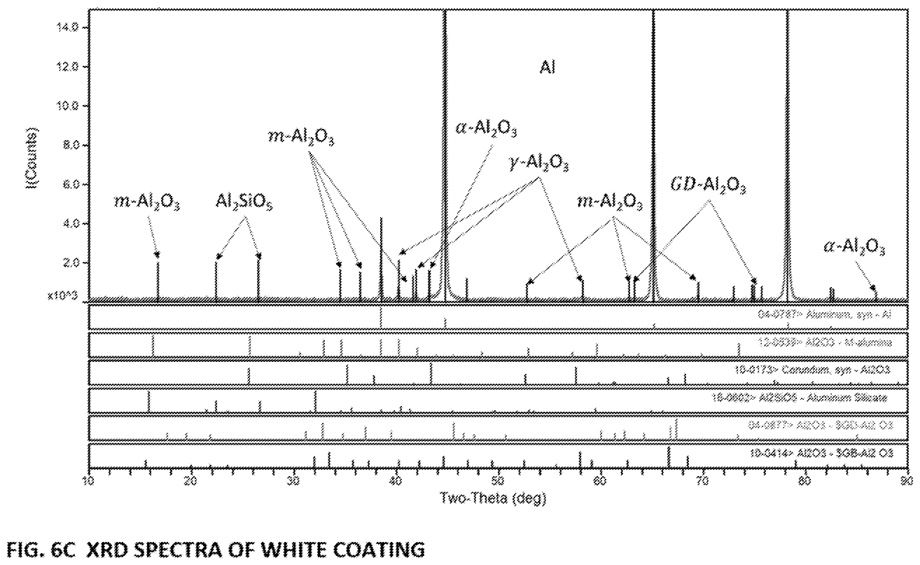

In one example the anodising surface depends on a maximum anodising voltage which is in part determined by the size of the nanoparticles in the bath. The coating formed at 85V as seen in FIG. 5C at 509 is associated with small particles 510 of between 20 and 100 nm, possibly oxides and hydroxides of the metal nanoparticles, e.g., titania particles, produced by condensation of the tertiary butoxide. These small particles allow the metal to incorporate onto the growing anodic surface, 511, as aluminium-metal compounds (FIG. 6B) complexes (TiAlO₂). Larger particles between about 100 nm and about 500 nanometres (FIG. 5D at 512), can also adsorb on the anodised surface as an adherent electrophoretic layer of titania. The largest particles, >500 nm, only participated in the anodic surface formation but did integrate into the coating. FIG. 5E at 513 depicts an anodised surface formed in a bath containing about 1700 nm particles from which the maximum sustained anodising voltage was between about 85V and about 100V which substantially affected the surface and bulk nanostructure producing a blue/white surface. While FIG. 5E at 514 depicts an SEM of a substantially white anodized surface prepared in a bath comprising about 3000 nm particles at 150V.

In another example where the nanoparticle source is Zirconium propoxide. Due to the different interactions between the bath and the nanoparticles, much smaller particles, typically <200 nm, produce identical anodising outcomes.

At step 308 of FIG. 3 the aluminium substrate has been anodised forming an anodised substrate having an anodised surface. The anodised substrate is removed from the anodising bath and rinsed. After rinsing, the surface can be matte or gloss white, which depends on the aluminium substrate pre-treatment, however, incorporating additional white materials into the anodised surface and/or sealing the anodised surface can further enhance the whiteness.

Many surface colouring processes, known in the art, may be adopted with the current anodised surface to improve or change surface colour. The porosity of the white anodised surface makes it suitable for further colouration by methods that include dip organic dying of the surface, electrophoretic deposition of metal oxides or other materials, and electrolytic colouring using metallic salts.

One example to enhance the anodised surface whiteness involves immersing the anodised substrate in a bath suitable for enhancing whiteness, which for example contains an aqueous dispersion of barium sulphate particles. Preferably the barium sulphate particles are a barium sulphate nano powder. Preferably the bath suitable for enhancing whiteness comprises between about 0.01 mol/L and about 0.5 mol/L of barium sulphate nano powder, or between about 0.05 mol/L and about 0.3 mol/L of barium sulphate nano powder, or preferably between 0.2 mol/L barium sulphate nano powder. Preferably, the barium sulphate nano powder has a mean particle diameter of about 100 nm or less (smaller than the pore size of the coating). An equimolar amount of disodium EDTA is sufficient to stabilise the particles in suspension. The bath for enhancing whiteness is agitated to significantly reduce particle agglomeration. The method further applies a voltage corresponding to an electric field of between about 1 V/cm and about 30 V/cm, or about 5 V/cm and about 25 V/cm, preferably about 20 V/cm between the substrate and an inert counter-electrode. The method adopts a voltage polarity according to the surface charge on the particles, which may be affected by particle size and surfactant properties and applies a constant voltage regime for between about 1 minute and about 30 minutes, or about 5 minutes and about 20 minutes, preferably for about 10 minutes, so that the barium sulphate particles are electrophoretically impregnated into the porous surface. Those skilled in the art will understand the proportional relationship between the applied electric field and the penetration depth of the nanoparticles.

The inventors determined that the white anodised substrate, having porous nanomorphology on the anodised surface, exhibited hydrophobic properties. These properties reduced the effectiveness of aqueous post-treatments. An alternate example utilised a dispersion of barium sulphate nano powder in an appropriate organic solvent mixture, in a concentration in the range defined above. In this example, the voltage corresponded to an electric field in the range of about 50 V/cm to about 200 V/cm, or about 60 V/cm to about 80 V/cm, preferably about 75 V/cm.

In an alternate example, to change the colour from white to a pastel colour, the process comprises immersion of the anodised substrate in a solution comprising an organic dye and organic solvent. The anodised substrate was immersed for a period of between about 10 minutes and about 20 hours. This was then subsequently dried. Drying methods could include in a compressed air stream, or baked in an oven to remove the solvent producing a dyed anodised surface. Suitable drying methods would be apparent to one of skill in the art. In one example the colour of the dyed anodised surface depends on the density of dye in pores within the anodised surface, and the depth of penetration of the dye.

At step 309 of FIG. 3, the process optionally includes the step of sealing the anodic surface. In one example a polishing step may precede the sealing step, to create a uniformly smooth surface to enhance the aesthetic appeal of the surface. Polishing may adopt any one of the commercially available methods depending on the size and shape of the anodised article. Such methods include buffing, burnishing, tumble finishing, vibratory finishing, soda blasting, etc. Polishing the surface prior to sealing may improve the effect of the sealing process.

Sealing the anodised surface increases its durability, increases its whiteness, preserves secondary colour, and improves its resistance to chemical attack, amongst other attributes. Sealing processes for anodic surfaces are well known in the art, including boiling water seals, metal acetate seals and polymer seals, etc, and most can be successfully applied to the anodised surface that is produced according to the present process.

One preferred example for sealing the anodised substrate comprising the anodised surface comprises: contacting the anodised substrate ace with sealing solution for a contacting period to provide a sealed anodised substrate; rinsing the sealed anodised substrate with an alcohol; curing the sealed anodised substrate at curing conditions. Preferably the anodised substrate is contacted with the sealing solution. Preferably the sealing solution is a sol-gel. Preferably the sol-gel is a silica-siloxane metal oxide sol gel. Preferably the sol-gel is prepared using a C₁₋₆ alcohol, preferably a C₃ alcohol, more preferably isopropyl alcohol. Preferably, contacting the anodised substrate with the sol-gel comprises electrophoretic deposition. Preferably, the electrophoretic deposition occurs between 30 V and 200 V, preferably 170 V. Preferably, the sol-gel infiltrates the anodised substrate for the contacting period. The contacting period may be between 10 minutes and 120 minutes, preferably 30 minutes. Preferably, rinsing the sealed anodised substrate with an alcohol comprises an alcohol selected from methanol, ethanol, propanol, isopropanol, butanol. Preferably, the curing conditions comprise a temperature of about 50° C., at least 50° C., or less than 80° C. Preferably, the curing conditions comprise a relative humidity above 80%.

One preferred example sealed the surface with a hybrid silica and siloxane-metal oxide sol-gel. Sealing used electrophoretic deposition at between 30V and 200V, preferably 170V with an ethanol rinsed white anodised surface as the cathode and an inert titanium anode to infiltrate the solgel into the coating for a period of between 10 minutes and 120 minutes, preferable 30 minutes; cured the sealed surface for over one hour at a temperature above 50° C. and relative humidity above 80%. The hybrid silica sol-gel was prepared using isopropanol, using a silicon of between 0.1 to 1 M with a mixture of 70 to 85% TEOS (tetra-ethyl-ortho-silicate), 10 to 20% OTES (octyl-tri-methoxy-silane), 5% HDTMS (hexa-decyl-tri-methoxy-silane), and 10 to 20% FAS (1H,1H,2H,2H-perfluorooctyl-tri-ethoxy-silane). 5 to 15 ml/L hydrochloric acid (37 vol. %) or phytic acid (50 vol. %) peptized the solution.

In an alternate example the colour and hardness of anodising surface can also be modified by the siloxane-metal oxide sol-gel, that is prepared by additional metal alkoxide in the hybrid silica sol-gel. In an example, 50 to 100 ml/L aluminium tri-sec-butoxide was added into the hybrid silica sol-gel, and 10 to 30 ml hydrochloric acid (37 vol. %) peptized the solution.

In an alternative example the anodised surface may be sealed with a benign material, such as sealing with a phytic acid solution. Phytic acid (PA, 70 wt. % in water) from Sigma Aldrich, and deionized water were used to prepare about 2.5 wt. % PA solution, small amounts of triethylamine from Sigma Aldrich, the amount of triethylamine being sufficient to adjust pH of the phytic acid solution to about pH 1.2-2.0, preferably to about pH 1.5 to provide a sealing solution. The phytic acid sealing solution was heated to about 90° C. The anodised substrate was submerged in the sealing solution for about 15 min, which produced a deposition film (sealing film) of about 3-4 μm on the surface of the anodised substrate.

In an alternative example the anodised surface may be sealed using a commercially available sealant such as Lyndar Clearcoat Aerosol. Lyndar Clearcoat Aerosol compound was sprayed on the anodised surface of the anodised substrate to deposit a transparent sealant of about 20 μm. The transparent sealant was cured for about 24 hours. The resultant coating exhibited improved durability and nearly 100 times higher gloss than the as prepared coatings. The inventors observed that this sealing technique does not impact the L* value of the white anodized coating while imparting a high gloss to the surface.

In an alternative example the anodised surface may be sealed using a metallic clear coat sealant. Here, metal deposition techniques such as physical vapor deposition (PVD), chemical vapor deposition (CVD), atomic layer deposition (ALD) and pulsed laser deposition (PLD) may be used to provide a uniform nano-scale seal on the anodised surface. In a preferred example, PLD of thin metal-based coatings were deposited on a white anodic surface. Deposition may be performed at about 1 J/cm² laser fluence in a low oxygen environment on an as-prepared white anodized coating.

The metal oxide layer was sufficiently thick to completely seal the nanoporous structure of the anodic coatings without altering the aesthetical appearance or tactile behaviour. The metal-based sealants included but are not limited to indium tin oxide, vanadium oxide, zinc oxide.

At step 310 of FIG. 3 the process ends.

### EXAMPLES

The following examples describe specific operating conditions and illustrate the practice of the disclosure. However, these examples are not to be considered as limiting the scope of the disclosure. The selected examples specifically illustrate aspects of the anodising bath and process to produce white anodised surfaces.

In each example the outcome is determined by the degree of whiteness of the process. Colour measurement often adopts the CIE 1976 L*a*b* colour space standard, used herein to measure the colour of anodised surfaces. Measurement instruments adopted were NR10QC colour meter, and GC268 reflectometer. Measuring light and white colours with a CIE L above 85 is subject to significant error, especially for structurally coloured surfaces, and the measurement may change with the light contact angle, thus measurements were cross-checked against Resene Paints colour swatches to provide increased accuracy.

### Example 1—The Effect of Bath Composition

To develop an understanding of the theoretical basis for the anodising process various anodising bath compositions and formulation approaches were tested. The anodising bath composition comprised 25 g/L oxalic acid, 10 g/L boric acid, 1 g/L citric acid, and 1 ml/L Tween 20 surfactant. In all experiments anodising bath agitation was performed at 300 rpm magnetic stirring and 70 degrees C., maintained on a hotplate stirrer and using a water bath. In experiments including butoxide, the butoxide concentration was 47 mL/L. Anodising bath pH in all cases ranged between 2 and 2.4 pH units. Table 1 shows the range of bath additives and processes.

TABLE 1

| | | | Voltage | | |
|---|---|---|---|---|---|
| | Anodising Bath | | Range | Bath | Surface |
| Bath | Description | Particles | (V) | Appearance | Appearance |
| 1.1 | Anodising bath | No | 30 | Clear | Metallic |
| | no additives | | | | surface |
| 1.2 | Bath + Ti | Yes | 150-250 | Milky white | White |
| | butoxide (aged) | | | | |
| 1.3 | Bath + butanol | No | 30 | Clear | Solid |
| | | | | | violet/grey |
| 1.4 | Bath + Butanol + | Yes | 40-107 | Milky brown | Blue, white |
| | TiO₂ powder | | | | |
| 1.5 | Bath + Al tri- | Yes | 26-436 | Clear | Grey |
| | butoxide | | | | |
| | (unaged) | | | | |
| 1.6 | Filtered bath 1.2 | No | ~150 | Clear | Dark grey |

All substrate samples were 2×3 cm 6061-T6 aluminium coupons, jigged for connectivity using a 2 mm insulated 4000 series aluminium welding wire. The wire was force fitted into a 1.8 mm hole drilled into the centre top of the aluminium substrate sample. The aluminium substrate was pre-treated using an Activax alkaline soak at 60 degrees Celsius for 8 minutes followed by a de-smut in 50% nitric acid for 1 minute.

Referring to anodising bath 1.1 from Table 1, results demonstrated that the mixture of organic acids alone was insufficient to produce a sufficient anodic oxide layer. The maximum voltage reached was about 30 V and the resultant anodic structure appeared to have an incomplete collapsed anodic morphology (see FIG. 5H, 518). The inventors also determined that a substrate without sufficient native oxide layer failed to even achieve an initial voltage of 30V, indicating that the anodising bath alone did not build an initial barrier layer, and that the aluminium substrates appear to require the native oxide layer to be anodised.

Referring to anodising bath 1.2 from Table 1, results demonstrated that an aged bath, comprising a combination of 25 g/L oxalic acid, 10 g/L boric acid, 1 g/L citric acid, 1 ml/L Tween 20 surfactant, and hydrolysed tertiary butoxides, produced a ‘white’ coating with an L* value of >90. The maximum voltage reached was 150 V. The resultant anodised surface appeared to have a non-uniform, nanoscale pores of 50 to 100 nm (FIG. 5A, 506) on its surface. The cross-section image (FIG. 5A, 501) showed that the ~38 mm coating exhibited three-stage morphological development. Without wishing to be bound by theory the inventors believe this was responsible for scattering and diffusing incident light, and thereby provided the anodised substrate comprising the anodised surface having a substantially white appearance. The inventors determined that particles, esters, and butanol derived from hydrolysed tertiary butoxides in combination with organic acids may be responsible for inducing the white colour to the anodic coating.

Referring to 1.3 in Table 1, this investigated the function of butanol in producing an anodising structure of the anodised surface. Condensation of butoxide in the bath released butanol (equation 1 above). The results of this experiment suggested that butanol alone did not allow the production of a significant anodised layer, because the voltage did not rise. However, the presence of butanol did modify the anodising surface and its structure because the surface changes colour. FIG. 5C, 519, 510, 511 shows the pore structure of the anodised surface when produced by anodising bath 1.3. The ~30 nm pores are characteristic of the anodising bath and the anodising voltage.

In the experiment with bath 1.4, the addition of 25 nm TiO₂ powder supported the creation of a coloured anodising film, as demonstrated by both the voltage rise and surface appearance of the anodised surface. Thus, the presence of nano particles and butanol derived compounds in the anodising bath was determined to be important to the anodising process.

A further experiment, not included in Table 1, also showed that TiO₂ nano particles without butanol were insufficient to create the anodised surface. FIG. 5F, 515 is an exemplar image showing the surface morphology of aluminium anodised in an anodising bath with TiO₂ nanoparticles and no butanol. The coating appears discontinuous and has exposed grain boundaries. Higher magnification image, 516, shows that this anodising bath composition generated a poor anodic structure of the anodised surface having collapsed nanotubes.

The experiment with bath 1.5 of Table 1, filtered particulates from the anodising bath from experiment 1.2. Remaining liquid constituents were sufficient to develop a relatively thick anodised structure, since the anodising voltage reached 150V. However, the anodising bath did not support production of a white anodised surface. Rather the anodising current fell to zero over a period of about 20 minutes producing a grey surface with a translucent nano porous surface, FIG. 5G. 517.

An orthogonal experiment demonstrated a wide range of anodising bath acid concentrations produce white anodic surfaces. Table 2 presents a range of anodising bath formulations together with the anodised surface colour produced.

TABLE 2

| | Oxalic | Boric | Citric | Tween | | CIE | | |
|---|---|---|---|---|---|---|---|---|
| Anodising | Acid | Acid | Acid | 20 | TiOBU₄ | Colour | | |
| Bath | g/L | g/L | g/L | mL/L | mL/L | L* | a* | b* |
| 2.1 | 14 | 5 | 1 | 1 | 24 | 90.04 | −2.47 | −0.94 |
| 2.2 | 14 | 10 | 1 | 1 | 72 | 85.13 | −1.98 | −1.47 |
| 2.3 | 14 | 15 | 1 | 1 | 48 | 86.17 | −1.98 | −1.09 |
| 2.4 | 28 | 5 | 1 | 1 | 72 | 90.89 | −2.28 | −0.73 |
| 2.5 | 28 | 10 | 1 | 1 | 48 | 91.3 | −2.12 | −0.19 |
| 2.6 | 28 | 15 | 1 | 1 | 24 | 91.18 | −1.95 | −0.61 |
| 2.7 | 42 | 5 | 1 | 1 | 48 | 84.36 | −476 | −4.55 |
| 2.8 | 42 | 10 | 1 | 1 | 24 | 85.85 | −4.31 | −3.67 |
| 2.9 | 42 | 15 | 1 | 1 | 72 | 85.58 | −4.36 | −3.85 |

Table 2 shows the results from anodising using the standard anodising voltage current profile, except where noted. Each experiment first formulated a fresh bath with the target chemistry. The experiment initially anodised a pre-treated aluminium substrate coupon (as above) 5 cm×3 cm until the voltage reached 150V, this process sufficiently aged the bath to produce a suspension of ~3-micron titania particle and the associated butanol derived esters.

The process initially anodised at 2A/dm² constant current for 1 minute, thereafter, current density was linearly increased to 4 A/dm² over a period of 3 minutes. Then DC supply was switched to constant voltage when the voltage reached 150V and anodising continued to a total of 120 minutes.

In each experiment the bath temperature was maintained at between about 60 and about 80 degrees Celsius.

While the data demonstrated that an oxalic acid concentration of about 28 g/L with a boric acid concentration of about 5 g/L and the butoxide concentration of about 24 g/L produced the whitest surface, the oxalic acid concentration appeared to be the most crucial factor.

The ratio of oxalic acid to boric acid also appeared to be important at low oxalic acid concentrations, and it was noted that a ratio of about 3:1 produces the whitest surfaces. Ratios below 2:1 appeared to increase the rate of initial anodising with the process reaching peak anodising voltage in a short time. When the oxalic to boric concentration was about 1:1 the bath would not support 4A/dm².

While the amount of butoxide does not appear to affect the surface lightness, lower quantities appeared to improve the purity of the colour.

### Example 2—Tertiary Butoxide Particle Development

Table 3 depicts a range of metal butoxide particle forms together with the anodised surface colour produced. Anodising baths 3.2, 3.2 and 3.4, adopted 47 g/L of titanium butoxide. Anodising bath 3.1 contained no butoxide.

TABLE 3

| | Particle | Zeta | Voltage | | Thick- | CIE | | | |
|---|---|---|---|---|---|---|---|---|---|
| | Size | potential | Limit | Time | ness | Colour | | | Bath |
| No | (nm) | (mV) | (V) | (Mins) | (μm) | L* | a* | b* | Notes |
| 3.1 | None | — | 56 | 120 | 33 | 68.69 | 0.77 | 1.86 | Clear |
| 3.2 | 80 | 0.043 | 85 | 70 | 32 | 69.87 | −3.44 | −6.73 | Clear, new |
| 3.3 | 1767 | −0.102 | 120 | 70 | 10 | 75.43 | −0.23 | 5.00 | Milky brown |
| 3.4 | 3037 | −0.283 | 150 | 120 | 40 | 91.3 | −2.12 | −0.19 | Milky white |

Sample pre-treatment and preparation followed the procedure in Example 1 above.

The bath temperature adopted was 60 degrees Celsius with magnetic agitation at 600 rpm.

Experiment 3.1 of Table 3 anodised a sample in a bath containing no tertiary butoxide. The bath remained clear, and the anodised structure was insufficient to colour the surface.

Experiment 3.2 added 47 g/L of titanium tertiary butoxide from Sigma Aldrich to the bath. The experiment controlled the current density to retard butoxide condensation reactions and allow investigation of the various anodising surface's structures developed under different particle development stages. The surface formed from a substantially clear butoxide containing anodising bath, i.e., a bath with nascent particles below 100 nm. The results demonstrate that the state of anodising bath particle development appears to be important in developing a white anodised surface. Normally, a tertiary butoxide added to a hot acidic solution completes condensation immediately, however this experiment appears to show that while the condensation reaction may proceed initially the particles are stabilised at a nanoscale in the anodising bath. The surface produced was relatively thick and exhibited a translucent violet colour, FIG. 5E 513.

The results from experiment 3.3 demonstrated that partially developed oxide particles support the formation on an anodic surface, however the structure of the oxide particles still limits the voltage growth by allowing free interchange of materials between the anodising bath and the pore structure. The surface's structure developed is like that of a coating from an anodising bath containing fully formed particles, however some electrophoretic TiO₂ deposits bind to the anodic surface (FIG. C 510) and the resulting surface is blue/white.

Experiment 3.4 shows that a fully formed anodising bath with ~3000 nm sized particles produced a white anodised surface on an aluminium substrate. Experiment 4 used a current controlled voltage ramp, followed by voltage controlled current ramp. The process adopted a first current at 2 A/dm² and applied for 3 mins, followed by application of a second current at 3 A/dm² for 3 mins. The current was increased to a third current of 4 A/dm² and held at this value until the voltage reached 150 V. At this stage, the process switched to a constant voltage control stage where 150 V was supplied for 120 mins. The resultant anodising surface is white and has an L* value of 91.3. The ~35 mm coating exhibited a non-uniform nanoporous morphology as observed in FIG. 5E, 514. The results also demonstrated that the large 3037 nm sized particles did not integrate into the anodising surface but substantially affected the surface and bulk nanostructure producing a white surface.

### Example 3—Anodising Surface Development

Degreased 3×5 cm Al6061-T6 samples were utilised and immersed in a preprepared white anodising bath formulated according to Table 2 above. The aluminium substrates were anodised for various periods between 5 minutes and 2 hours, then the samples were removed from the anodising bath and rinsed in deionised water.

After colour measurement using a colour meter, cross sections were prepared for SEM analysis.

SEM analysis determined both the pore and surface development together with coating thickness.

TABLE 4

| | Anodising | Anodising | Thick- | Pore | CIE | | | |
|---|---|---|---|---|---|---|---|---|
| Sample | bath (see | Time | ness | Diameter | Colour | | | Morphology |
| No | Table 2) | (mins) | (μm) | (nm) | (L*, a*, b*) | | | Comments* |
| 4.1 | 2.1 | 5 | 1-3 | 10-20 | 67.98 | 1.05 | 7.33 | UNP |
| 4.2 | 2.2 | 10 | 4-7 | 40-80 | 67.33 | −0.94 | 1.05 | BNP denser |
| | | | | | | | | surface layer |
| 4.3 | 2.3 | 15 | 5-7 | 60-100 | 71.02 | −1.3 | −0.68 | BNP, DNP, |
| | | | | | | | | dense surface |
| | | | | | | | | layer |
| 4.4 | 2.4 | 20 | 10-13 | 80-100 | 71.53 | −1.05 | −1.12 | As for No 3 |
| 4.5 | 2.5 | 30 | 15-20 | 100 | 78.15 | −2.64 | −2.96 | DNP, dense |
| | | | | | | | | surface layer |
| 4.6 | 2.6 | 60 | 20-25 | 100 | 85.59 | −2.28 | −2.35 | Dense DNP, |
| | | | | | | | | DNP, porous |
| | | | | | | | | surface layer |
| 4.7 | 2.7 | 90 | 30-40 | 100-150 | 90.01 | −2.55 | −0.79 | Dense BNP, |
| | | | | | | | | DNP, Dense |
| | | | | | | | | DNP |
| 4.8 | 2.8 | 120 | 40-50 | 200 | 91.3 | −2.12 | −0.19 | Dense BNP, |
| | | | | | | | | DNP, DNP |

*UNP = uniform nano porous,
BNP—branched nano porous,
DNP = discontinuous nano porous

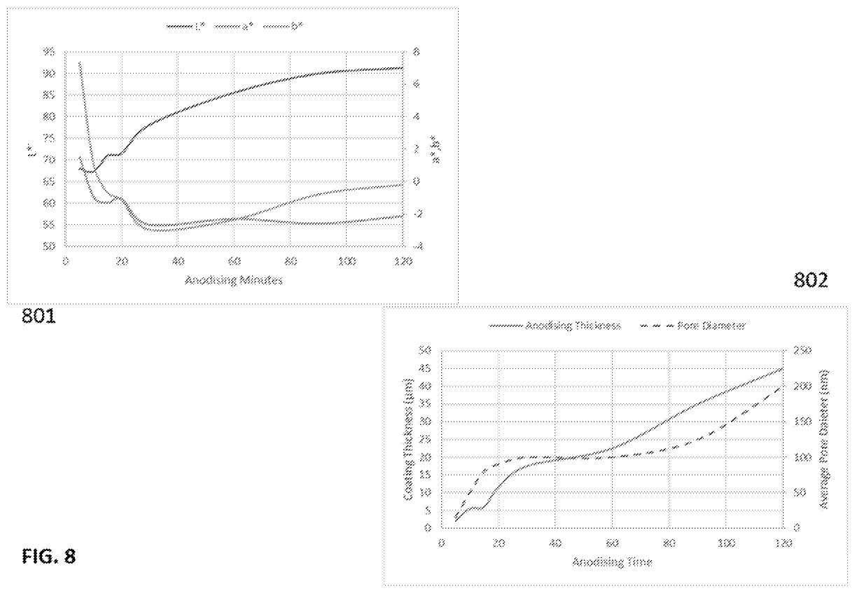

FIG. 8, 801 shows the evolution of sample colour with anodising time, using the data in Table 4, which also shows the evolution of the anodising morphology responsible for the surface whiteness.

Examples 4.2 to 4.4, demonstrate that the surface colour of the anodised surface was created by a combination of the surface's structure and thickness. Where the total surface thickness is less than 20 microns there appeared to be insufficient interactions between the incident light and the pore/alumina interfaces to reflect a significant percentage of the incident light. However, it was observed that as the surface thickness grew the number of interactions multiplied and the coating became whiter.

It was observed that thinner samples appeared to have a bluer hue, thought to be a characteristic of the nano-pore dimensions (Sample number 1). However, as the coating got thicker it was observed that colour became greener, b* became less negative and a* became more negative. The colour change was thought to result from the larger pore diameter at the coating surface caused by acid dissolution of the alumina.

### Example 4—Gloss Surface

Sample pre-treatment and preparation followed the procedure described in Example 1 above.

The electropolishing step may adopt one of many well-known electropolishing processes for aluminium substrates. Here the electropolishing bath composition comprised 800 ml/L Phosphoric acid, 30 ml/L Hydrofluoric acid, 70 ml/L Sulfuric acid and 100 ml/L glycerine. Electropolishing bath temperature was retained at 80 degrees C. A constant DC voltage 12V was applied for 2-3 min follow by a deionised water rinse. The process developed a mirror surface on the aluminium alloy surface with an Ra of ~0.1.

The electropolished sample was anodised in a burned-in bath 2.5 of example 1, Table 2. Anodising constant current density was 2 A/dm², and applied for 8 minutes, then increased to 3 A/dm² for 5 minutes, and increased for a third time to 3.5 A/dm² for a further 5 minutes. Thereafter the constant voltage anodising was applied at 150V once the voltage under the final constant current period reached 150V, and anodising continued for a total of 75 minutes.

The resulting surface was substantially white with a colour measured as 87.3, −2.77, −1.63, L*a*b* and a surface gloss measured at 85° of 88.5 GU (gloss units).

### Example 5—Coloured Surface Preparation

White anodised samples were prepared using bath and process 1.2 in Example 1 above.

Anodised samples were completely dried by baking in a temperature-controlled oven at 120 degrees for 2 hours.

The dried samples were suspended for 20 hours in a solution of 0.01 g/L methylene blue dissolved in either deionised water or in ethanol.

The samples were removed from the methylene blue solution and dried with compressed air.

The colour of the samples was measured using a colour meter with the results reported in Table 5.

The methylene blue in water reduced the reflectivity of the surfaces as indicated by the lower L* and produces a baby blue surface. The methylene blue in alcohol however creates a substantially bluer surface.

The inventors believe that the surface is only partially wetting which limits the penetration of water into the pores, however alcohol penetrates the pores more readily. FIG. 9, 903 shows the wetting behaviour of white anodized samples with deionized water. The water contact angle of the droplet is ~40°.

TABLE 5

| | Anodising | Initial CIE | | | Final CIE | | | |
|---|---|---|---|---|---|---|---|---|
| | Time | Colour | | | Colour | | | Com- |
| No | (mins) | L* | a* | b* | L* | a* | b* | ments* |

| | | | | |
|---|---|---|---|---|
| 5.1 | 120 | 92.32 −2.19 −0.31 | 87.13 −5.16 −6.74 | Water |
| | | | | base dye |
| 5.2 | 120 | 87.86 −1.91 −0.69 | 73.49, −4.63, −15.33 | Ethanol |
| | | | | base dye |

### Example 6—Sealing the White Anodic Surface with Clearcoat

White anodised substrates were prepared using anodising bath and process 1.2 detailed in Example 1 above. The anodised substrate's surface exhibited an L* value of about 92.16.

The surface of the anodised substrate was sealed using a commercially available clear coat sealant such as Lyndar Clearcoat aerosol. Applying the clear coat sealant initially rendered the surface slightly translucent significantly decreasing the L* value as the solvents in the sealant entered in the anodising pores and changed the optical properties of the surface.

The clear coat was sprayed on the anodised surface and allowed to cure for about 2 hours. Once the solvents from the sealant evaporated, the whiteness of the surface was restored to a value consistent with whiteness prior to application of the sealant with a measured L* value of 92.1. The sealant was completely cured after 24 hours.

The sealed anodised surface was white and exhibited higher gloss than unsealed anodised surface due to the nature of the sealant. Unsealed surface had a gloss measured at 85° of approximately 1.3 GU (gloss units), while after sealing the GU increased to 90.1.

### Example 7—Siloxane Alumina Seal of the White Anodic Surface

White anodised substrates were prepared using the anodising bath and process 1.2 detailed in Example 1 above. The colour of the prepared white surface was measured using optical colourimetry and had an L* value of about 92.75.

About 400 mL of siloxane alumina sol-gel was prepared. A of mixture of 21 ml TEOS (tetra-ethyl-ortho-silicate), 2 ml HDTMS (hexa-decyl-tri-methoxy-silane) within 360 ml isopropanol was vigorously stirred; then 25 ml aluminium-tri-sec-butoxide was added using syringe; followed with 12 ml hydrochloric acid (37 vol. %) dropwise to peptize the sol. The suspension transformed from turbid to clear after 5 to 10 mins stirring to provide a suitable seal for the anodised surface. However, stirring for extended period (such as 4 hours or more) to substantially complete hydrolysis and condensation reactions) produces superior results.

The white anodised surface was rinsed with ethanol to prepare for electrophoretic deposition.

Electrophoretic deposition for about 30 minutes provided infiltration of the siloxane alumina sol-gel into the anodised surface. Deposition occurred at 170 V DC using the white anodised surface as cathode and parallel titanium anodes to provide a sealed anodised surface.

Sealed anodised substrate having the anodised surface was initially air dried for 30 minutes, and then cured for 1 hour at about 50° C. in a humidity-controlled environment, with a RH over 80%.

Colorimetry measurements of the sealed anodised surface demonstrated a slight increase in the L* value, around 0.5 units, to 93.23.

Post sealing heat treatment at 200° C. for 4 hours increased hardness of the sealed anodised surface to over 206 HV_{0.1}. Without wishing to be bound by theory the inventors believe that the a alumina in the anodising pore walls catalyse the transformation of amorphous alumina in the sol/gel to a more robust boehmite form.

The sealed anodised surface remained white, exhibited superhydrophobic properties with contact angle over 150°, FIG. 9, 904, and had superior chemical and wear resistance due to the silica-alumina sealant.

### Example 8—Organic Particles Source Replacement

Baths in which the alkoxide component was replaced with high molecular weight polyethylene glycol produced near white anodised surfaces on the aluminium substrate.

50 mm×30 mm×1.2 mm Al 7075 series substrates were pre-treated and prepared followed the procedure in Example 1 above.

A white anodising bath was prepared comprising 42.5 g/L oxalic acid, 10 g/L boric acid, 1 g/L citric acid, 42 mL/L 2-propanol and 15 mL/L PEG MW 400.

A bath temperature of 30±4° C. degrees Celsius was required for a purely organic bath. The bath was stirred using magnetic agitation at 600 rpm.

Constant current anodising at 4 A/dm² was performed using a stainless-steel cathode until the anodising voltage reached 150V, about 60 minutes. The rectifier was switched to constant voltage mode for the remainder of the anodising period. The samples were anodised for a further 120 minutes, until a terminal current density of 2 A/dm² was achieved. Anodised samples were removed from the bath, rinsed and dried with compressed air.

Colour measurements performed using a 3 nh ASTM D1500 colour meter from Shenzen ThreeNH Technology. The surfaces had an L*a*b* measurement of 88.65, −3.66 and 0.22 respectively demonstrating that the particle free bath produced white surfaces.

### Example 9—Organic Bath with Particles

Organic baths containing a low amount of an alkoxide were able to produce white surfaces.

50 mm×30 mm×3 mm Al 7075 series aluminium substrates were pre-treated and prepared followed the procedure in Example 1 above.

An organic and particle bath was formulated using both long chain organic particles and a lower quantity of metal alkoxide. This bath comprised 42.5 g/L oxalic acid, 10 g/L boric acid, 1 g/L citric acid, 42 mL/L 2-propanol, 15 mL/L PEG MW 400 and 10 mL/L Zirconium propoxide.

Constant current anodising at 4 A/dm² was performed using a stainless-steel cathode until the anodising voltage reached 150V, about 30 minutes. The rectifier was switched to constant voltage mode for the remainder of the anodising period. The samples were anodised for a further 120 minutes, until a terminal current density of 2 A/dm² was achieved. Anodised substrates were removed from the bath, rinsed, and dried with compressed air.

Colour measurements performed using a 3 nh ASTM D1500 colour meter from Shenzen ThreeNH Technology. The surfaces all had an L* measurement of over 91 demonstrating that a bath containing a lower quantity of alkoxide, and long chain organic can produce white surface.

As shown in the results and as detailed above, an advantage of the method described above is the provision of a single step anodising process using a bath comprising one or more organic acids, including a hydrolysed metal alkoxide capable of directly creating a substantially random anodising surface structure. The anodising surface structure itself rather, than any secondary material, reflects a wide bandwidth of visible frequencies, producing a surface lightness (L*) greater that 91 when measured on the CIE Lab* scale, with a colour component (a*, b*) of less than 2, i.e., a substantially white surface.

In this specification where reference has been made to external sources of information, including patent specifications and other documents, this is generally for the purpose of providing a context for discussion the features of the present invention. Unless state otherwise, reference to such sources of information is not to be construed, in any jurisdiction, as an admission that such sources of information are prior art or form part of the common general knowledge in the art.

The present invention and its examples have been described in detail. However, the scope of the present invention is not intended to be limited to the particular examples of any process, manufacture, device, means, methods and/or steps described in the specification. Various modifications, substitutions, and variations can be made to the disclosed materials without departing from the spirit and/or essential characteristics of the present invention. Accordingly, one of the ordinary skills in the art will readily appreciate from the disclosure that later modifications, substitutions and/or variations performing substantially the same function or achieving substantially the same result as examples described herein may be utilized according to such related examples of the present invention. Thus, the following claims are intended to encompass within their scope, modifications, substitutions, and variations to features, components, kits, means, and/or methods disclosed herein.

1-55. (canceled)

56. An aluminium anodising process to produce a white or substantially white anodised surface on an aluminium substrate, the process comprising the steps of:
i. Pre-treating an aluminium substrate;
ii. Immersing the aluminium substrate in an aqueous anodising bath comprising:
a buffer,
one or more particle sources,
and one or more carboxylic acids; and
iii. anodising the aluminium substrate by following an anodising current and voltage regime to provide an anodised substrate comprising the white or substantially white anodised surface.

57. The process according to claim 56, wherein the pre-treatment step comprises one or more selected from:
i. an alkaline degreasing step;
ii. an acid cleaning step; and
iii. an electropolishing step.

58. The process according to claim 56, further comprising one or more selected from:
i. addition of a C₁₋₆ alcohol to the aqueous anodising bath, or addition of methanol, ethanol, propanol, or butanol; and
ii. a surfactant.

59. The process according to claim 56, wherein the one or more particle sources is selected from:
i. one or more metal oxide particles, one or more metal oxide nanoparticles or microparticles;
ii. one or more hydrolysable metal alkoxides, titanium butoxide, titanium isopropoxide, aluminum tri see butoxide, zirconium butoxide, and combinations thereof;
iii. one or more low molecular weight polymers, polyethylene glycol 400;
iv. one or more long chain organics;
V. succinic acid;
vi. a combination of succinic acid and a metal oxide powder,
vii. a combination of succinic acid magnesium oxide powder; and
viii any combination thereof.

60. The process according to claim 57, wherein the one or more particle sources is one or more hydrolysable metal alkoxides having a concentration in the aqueous anodising bath between about 10 g/L and about 70 g/L.

61. The process according to claim 58, wherein the addition of the C₁₋₆ alcohol is by in situ hydrolysis of a hydrolysable metal alkoxide particle source to form one or more metal oxide particles and the C₁₋₆ alcohol during the anodising step.

62. The process according to claim 56, wherein
i. the one or more carboxylic acids are selected from:
oxalic acid,
citric acid,
a combination of oxalic acid and citric acid,
oxalic acid having a concentration between about 10 g/L and about 70 g/L, and
citric acid having a concentration between about 1 g/L and about 10 g/L; and
ii. the buffer is boric acid, or the buffer is boric acid having a concentration of between about 5 g/L and about 20 g/L of boric acid.

63. The process according to claim 58, wherein the surfactant is selected from: a non-ionic surfactant, cationic surfactant, and Tween 20.

64. The process according to claim 62, wherein the C₁₋₆ alcohol is substantially evaporated from the bath and/or converted to oxalates or oxalate esters.

65. The process according to claim 56, wherein the one or more particle sources comprises metal oxide nanoparticles that are added to the aqueous anodising bath, providing a concentration in the aqueous anodising bath of between about 1 g/L and about 10 g/L.

66. The process according to claim 56, wherein the anodising current and voltage regime comprises:
i. a first anodising stage comprising application of a first current density for first period;
ii. ramping the first current density to a second current density and voltage for second period to provide a second anodising stage, wherein the second current density is higher than the first current density;
iii. anodising at the second anodising stage until the voltage reaches an anodising voltage threshold;
iv. switching the second current density to a voltage control stage comprising a constant anodising voltage and anodising current density for a voltage control period.

67. The process according to claim 66, wherein the first anodising stage comprises one or more selected from:
i. a first current density between about 0.5 A/dm² and about 3 A/dm²; and
ii. a first period of between about 30 seconds and about 1.5 minutes, or between about 15 minutes and about 75 minutes.

68. The process according to claim 66, wherein the second anodising stage comprises one or more selected from:
i. a second current density between about 2 A/dm² and about 8 A/dm²; and
ii. a second period of between about 5 minutes and about 25 minutes.

69. The process according to claim 66, wherein the voltage control stage is maintained at a constant anodising voltage and anodising current for a voltage control period between about 10 minutes and about 120 minutes; and is held until the anodising current falls to a value that is 10% below the first current density.

70. The process according claim 66, wherein the anodising voltage threshold is between about 80 V and about 300 V.

71. The process according to claim 66, wherein the first current density comprises a first step, a second step, and a third step; and wherein,
i. the first step of the first current density comprises a current density of between about 0.5 to about 3 A/dm²; and is held for between about 5 minutes to about 25 minutes;
ii. the second step of the first current density is between about 2 A/dm² and about 4 A/dm²; and is held for between about 5 minutes to about 25 minutes; and
iii, the third step of the first current density is between about 3 A/dm² and about 5 A/dm²; and is held for between about 5 minutes to about 25 minutes.

72. The process according to claim 66, wherein the first anodising stage, the second anodising stage, and the voltage control stage each provide a crystalline layer in the anodised surface, and wherein each crystalline layer has different crystalline morphology.

73. The process according to claim 72, wherein the crystalline layer is a nanocrystalline layer.

74. The process according to claim 66, wherein
i. the first anodising stage provides an outermost substantially branched random nano porous layer having nanocrystalline walls located at an outermost position from the substrate;
ii. the second anodising stage provides a substantially nanocrystalline filled nanotubular middle layer;
iii, the voltage control stage provides a nanocrystalline bottom layer substantially in contact with the substrate and having greater density than the outermost and middle layer; and
wherein the substantially nanocrystalline filled nanotubular layer is positioned between and substantially in contact with the substantially branched random nano porous layer having nanocrystalline walls and the nanocrystalline bottom layer having greater density than the outermost and middle layer.

75. The process according to claim 56, further comprising one or more selected from:
i. a step dyeing the anodised surface of the anodised substrate;
ii. a step sealing the anodised surface of the anodised substrate; and
iii. a step detaching the anodised surface from the aluminium substrate and processing to create a dense nano porous element.

76. An anodised surface configured on an aluminium substrate, the anodised surface comprising:
i. an outermost substantially branched random nano porous layer having nanocrystalline walls located at an outermost position from the substrate;
ii. a substantially nanocrystalline filled nanotubular middle layer;
iii. a nanocrystalline bottom later in substantially in contact with the substrate and having greater density than the outermost and middle layer;
wherein the substantially nanocrystalline filled nanotubular layer is positioned between and substantially in contact with the substantially branched random nano porous layer having nanocrystalline walls and the nanocrystalline bottom layer having greater density than the outermost and middle layer.
